(19) United States
(12) Patent Application Publication
(10) Pub. No.: US 2011/0258608 A1
(43) Pub. Date: Oct. 20, 2011

(54) METHOD AND APPARATUS TO LOCATE BOTTLENECK OF JAVA PROGRAM

(75) Inventors: Ying Li, Beijing (CN); Qiming Teng, Beijing (CN); Haichuan Wang, Beijing (CN); Xiao Zhong, Beijing (CN)

(73) Assignee: International Business Machines Corporation, Armonk, NY (US)

(21) Appl. No.: 13/086,609

(22) Filed: Apr. 14, 2011

(30) Foreign Application Priority Data
Apr. 15, 2010 (CN) 201010150110.8

(51) Int. Cl. G06F 9/44

(52) U.S. Cl. 717/127

(57) ABSTRACT

A method and an apparatus to locate a bottleneck of a Java program. The method to locate a bottleneck of a Java program includes the steps of: creating a helper thread in a Java process corresponding to the Java program, and attaching the helper thread to a Java virtual machine (JVM) created in the Java process; inserting a prober into an operating system kernel; monitoring states in the operating system kernel of Java threads in the Java process and sending a signal to the helper thread in response to detect that a Java thread is blocked; and retrieving call stack information from the JVM in response to receive the signal from the operating system kernel and locating the position in source code of the Java program that causes the block using the retrieved call stack information.

### CROSS-REFERENCE TO RELATED APPLICATIONS

This application claims priority under 35 U.S.C. §119 to Chinese Patent Application No. 201010150110.8 filed Apr. 15, 2010, the entire contents of which are incorporated herein by reference.

### BACKGROUND OF THE INVENTION

1. Technical Field

The present invention generally relates to detecting and locating bottleneck of a JAVA program. More specifically, the present invention relates to a method and an apparatus to detect and locate a bottleneck of a JAVA program by inserting a prober which is hooked to context switch in the OS scheduler and locating the cause of the bottleneck at the source code level.

2. Description of Related Art

In the prior art, there are many monitoring tools and bottleneck analysis tools. Various tools in the prior art are exemplified as follows.

For example, there are native bottleneck analysis tools that check one layer of the execution stack to locate a bottleneck. Such native layer bottleneck analysis tools include e.g. LockStat that provides statistics on locks. The defect of this bottleneck analysis tool lies in that, for each resource such as a lock, a dedicated tool is needed, as a result, for various resources in the native layer, many dedicated tools are needed to monitor and analyze each of the resources. Additionally, such bottleneck analysis tools are only able to monitor in the native layer (i.e., OS layer), but they cannot link events occurring in the native layer to corresponding portions in the Java source code.

Additionally, there are triage tools that look across tiers in a multi-tier architecture to locate a suspected bottleneck. These triage tools are mainly used for a Web developing frame of a multi-tier architecture. One example thereof is WAIT from the Watson Lab of IBM Research. The multi-tier architecture typically includes a Web tier, an application tier and a database tier. This triage tool can only identify a node (i.e. hardware server) that can cause a suspected bottleneck in the multi-tier architecture. Therefore, this triage tool identifies a node in a system including a plurality of nodes that causes a bottleneck, but it cannot locate the bottleneck in the source code.

Additionally, there are now Java runtime monitoring tools, such as jstack and JFluid. The jstack tool can perform a runtime stack analysis, but this tool has a significant performance overhead, and even causes perturbation to the application's behavior. The JFluid tool monitors all function calls that are associated with a particular resource. This tool also has a significant performance overhead, because all function calls will be recorded by the JFluid though not all of them are associated with thread stalling. Additionally, jstack and JFluid are monitoring tools at JVM layer and they monitor bottlenecks at JVM layer, but cannot monitor thread state in the native layer under the JVM layer.

U.S. Published Patent Application No. 2009/0319996 published on Dec. 24, 2009 and entitled “Analysis of Thread Synchronization Events” discloses analysis of thread blocking synchronization event based on determinations made using context switch data from a kernel thread scheduler and kernel-level thread unblocking data. Context switch data can include a switched-in thread identity, a switched-out thread identity, a switched-out thread state, at least one thread call stack, and a context switch time of occurrence. The application further discloses visualization to give a developer interactive access to source code responsible for a thread blocking synchronization event. The visualization can visibly link an unblocking event and a thread which is unblocked by the event. Some embodiments provide a call stack with resolved symbols (e.g., module, function name, line number) to show developers where in the code blocking APIs were called, in case the developers want to change that code.

In U.S. Published Patent Application No. 2007/0220515 published on Sep. 9, 2007 and entitled “Method and Apparatus for Analyzing Wait States in a Data Processing System” collecting information about threads, including call stack information, of threads entering a wait state is disclosed. A reason can be obtained as to why a thread entered the wait state. In addition the information about the set of threads can be analyzed to identify a pattern for a reason why threads are in the wait state. In the reference, a call is generated by a presently used operating system dispatcher located in operating system. This dispatcher is hooked or modified to generate a call or a branch to device driver when an event of interest occurs. When call is received from operating system, the device driver determines whether the dispatch is directed towards an idle processor thread or to a processor thread that is not idle in threads.

U.S. Published Patent Application No. 2008/0256339 entitled “Techniques for Tracing Processes in a Multi-Threaded Processor” discloses a technique for tracing processes executing in a multi-threaded processor. The trace process includes forming a trace message that has a virtual core identification (VOID) that identifies an associated thread. The trace message, including the VOID, is then transmitted to a debug tool.

### SUMMARY OF THE INVENTION

None of various tools in the prior art could accomplish a function of finding the exact position in Java source code that causes a bottleneck in native layer according to the bottleneck. Therefore, it is necessary to provide an effective method of linking a bottleneck in native layer back to Java source code.

The main object of the present invention is to provide a method and an apparatus to detect and locate a bottleneck of Java program. Additionally, the method and the apparatus have no obvious performance overhead and will not have an adverse effect on normal running of the target application.

According to one aspect of the present invention, there is provided a method to locate bottleneck of Java program including the steps of: creating a helper thread in a Java process that executes the Java program, and attaching the helper thread to the Java virtual machine (JVM) created in the Java process; inserting a prober into an operating system kernel; the prober monitoring, in the operating system kernel, the states of Java threads in the Java process, and sending a signal to the helper thread in response to detect that a Java thread is blocked; and the helper thread retrieving call stack information from the JVM in response to receive the signal from the operating system kernel, and locating the position in source code of the Java program that causes the block using the retrieved call stack information.

According to another aspect of the present invention, there is provided an apparatus to locate a bottleneck of Java program including: means for creating a helper thread in the Java process corresponding to the Java program and attaching the helper thread to a Java virtual machine (JVM) created in the Java process; means for inserting a prober into an operating system kernel; means for monitoring, in the operating system kernel, states of Java threads in the Java process, and sending a signal to the helper thread in response to detect that a Java thread is blocked, by the prober; and means for retrieving call stack information from the JVM in response to receive the signal from the operating system kernel and locating the position in source code of the Java program that causes the block using the retrieved call stack information, in the helper thread.

With the above apparatus and method of the present invention, it is possible to accurately link a bottleneck exhibited in native layer back to Java source code, i.e., to find a corresponding position in Java source code that causes the bottleneck in native layer. Therefore, the above method and apparatus can find the reason that the Java thread's state changes in the case where there are not any indications at JVM layer. Additionally, the above method is an independent, self-contained, and does not need the help of other monitors or tools. Furthermore, the above method has no obvious performance overhead and will not have an adverse effect on the normal running of a target application. Other characteristics and advantages of the invention will become obvious in combination with the description of accompanying drawings, wherein the same number represents the same or similar parts in all figures.

### BRIEF DESCRIPTION OF THE DRAWINGS

The present invention itself, embodiments, other objects and advantages thereof will be better understood with reference to the following detailed description of illustrative embodiments in conjunction with drawings, wherein:

FIGS. 1A and 1B illustrate the difference between thread states at JVM layer and thread states at native layer according to an embodiment of the current invention;

FIG. 2 is a schematic view illustrating the general inventive concept of the present invention according to an embodiment of the current invention;

FIG. 3 illustrates the flow of a method according to one embodiment of the present invention;

FIG. 4 is a schematic view illustrating a relationship between Java threads in user space and native tasks in kernel space according to an embodiment of the current invention;

FIG. 5 is a schematic view illustrating one example of the process for step 320 in FIG. 3 according to an embodiment of the current invention;

FIG. 6 is a schematic view illustrating one example of the process for step 340 in FIG. 3 according to an embodiment of the current invention; and

FIG. 7 is a schematic view illustrating an example of helper threads in the case of a quad-core processor according to an embodiment of the current invention.

Preferred methods and systems are now described with reference to the drawings, wherein like reference numerals are used to refer to like elements throughout. In the following description, for purposes of explanation, numerous specific details are set forth in order to provide a thorough understanding of the systems and methods, etc. In other instances, well-known structures and devices are shown in block diagram form in order to simplify the description. To those skilled in the art, many modifications and other embodiments can be conceived with advantages as taught in the description and drawings. Therefore, it should be appreciated that the present invention is not limited to the disclosed specific embodiments and alternative embodiments should be included in the scope of the present invention and the illustrative inventive concept. Though some specific terms are adopted in the present invention, they are only used in a general descriptive sense but not for a limiting purpose.

### DETAILED DESCRIPTION OF THE PREFERRED EMBODIMENTS

A detailed description of specific embodiments of the present invention will be made with reference to the drawings below. In the following description, terms “kernel space” and “user space” are mentioned with respect to address space where an element is executed in terms of the execution modes in an operating system. In the present invention, operating system can be various operating systems, such as Unix, Linux and Windows. For the sake of simplicity, in the present invention, only Linux is adopted as an example of operating system. However, those skilled in the art should understand that the method and apparatus of the present invention is applicable to other operating systems as well.

Java language is an object-oriented programming language that can program cross-platform application software. Java is different from a general compiling-and-executing computer language (e.g. C language) and a general interpreting-and-executing computer language (e.g. HTML) because it first compiles the source code into bytecode, and then interprets-and-executes the bytecode depending on the Java Virtual Machines (JVMs) on a variety of platforms. Thus, Java accomplishes the cross-platform characteristic of “compile once, run anywhere”.

As Java now has become the mainstream developing language for enterprise applications, it's very important to understand how a Java thread works. Especially when one enterprise application cannot utilize the underlying hardware server well, we need find out why those application threads are blocked while the CPU utilization is still low. In Java this is difficult because the Java application has many layers between hardware and application codes, including but not limited to, hardware layer, Operating System (OS) layer (also called native layer), Java virtual machine layer, middleware layer and application layer.

Due to the above reason, if we find the CPU utilization is low, it's very difficult to locate the problem in the Java source code. However, application developers need locate the problem in the Java source code so that they can fix it.

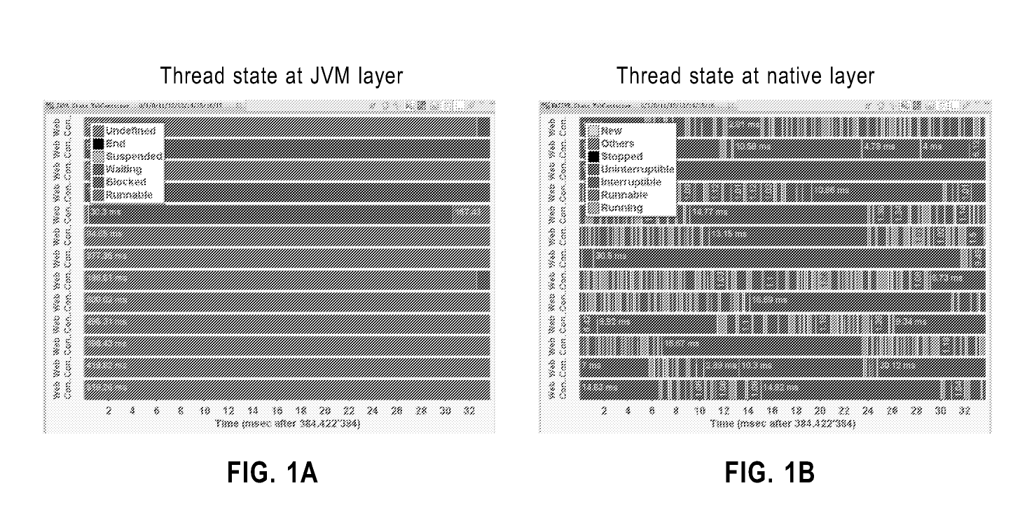

For example, in FIG. 1A that shows thread state at JVM layer, we find many application threads are runnable at JVM layer, and there is no obvious problem at JVM layer. But FIG. 1B shows thread state of threads at native layer that correspond to the threads at JVM layer. As shown in FIG. 1B, there are a lot of thread blocks. Therefore, Java application developers need to find out why threads are blocked when the CPU utilization is low and where in the source code is causing this problem.

The virtual address space of Linux is 0 to 4 G. The Linux kernel divides the space of 4 G bytes into two parts. The highest 1 G bytes (from the virtual address 0xC0000000 to 0xFFFFFFFF) are to be used by the kernel (called “kernel space”), while the lower 3 G bytes (from the virtual address 0x00000000 to 0xBFFFFFFF) are to be used by respective processes (called “user space”). Because each process can switch into the kernel mode by system scheduling, the Linux kernel provides services that are shared by all the processes within the system. Kernel codes and data are held in the kernel space while codes and data of user programs are held in the user space of process.

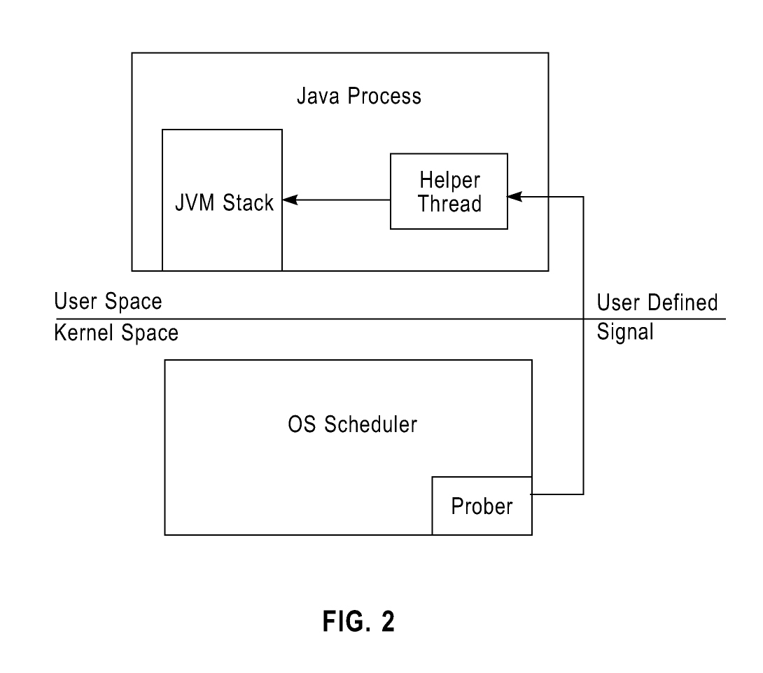

FIG. 2 is a schematic view showing the general inventive concept of the present invention. In the present invention, a helper thread is created in a Java process that is the monitored target, and a prober is inserted into scheduler of the operating system. When the prober detects that a thread in the Java process is blocked, it sends a user defined signal to the helper thread. The helper thread that receives the user defined signal retrieves call stack information at that time from the JVM stack, so that it is possible to locate the exact position in Java source code. Thus, accurately linking a bottleneck at native layer back to Java source code is accomplished.

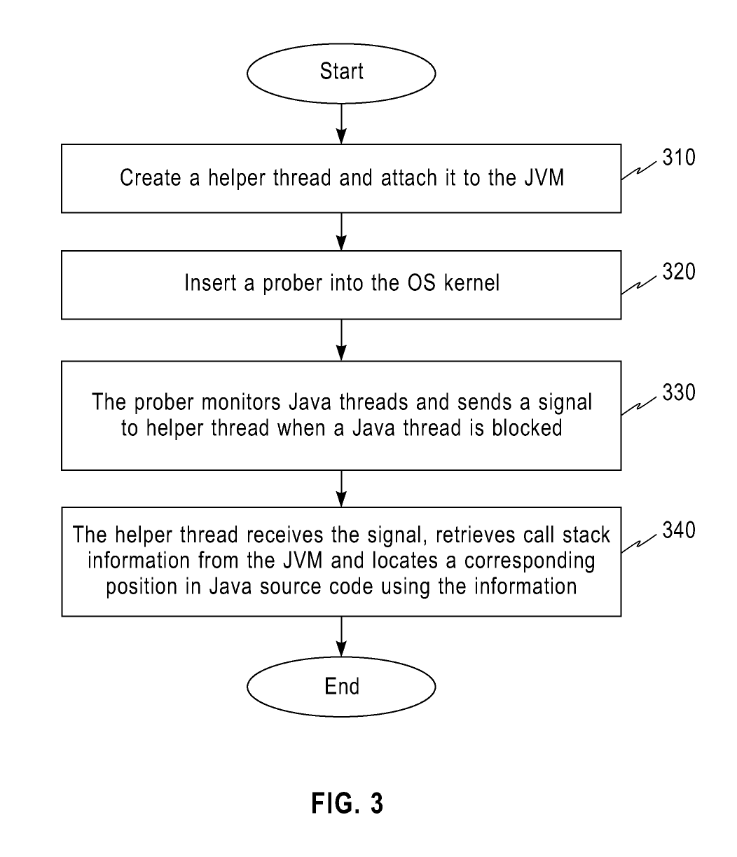

With reference to FIG. 3, the present invention provides a method to detect and locate a bottleneck of Java program. FIG. 3 shows a flow 300 of a method according to one embodiment of the present invention, including the following steps:

Step 310: create a helper thread and attach it to the JVM.

Step 320: insert a prober into the operating system kernel.

Step 330: the prober monitors Java threads, and sends a signal to the helper thread when a Java thread is blocked.

Step 340: the helper thread receives the signal, retrieves call stack information from the JVM and locates a corresponding position in Java source code by using the information.

It is noted that Java program is represented as a process in user space when it is executed. JVM corresponds to an independently running Java program, i.e. corresponds to a Java process. When a Java program is launched, a JVM instance is launched, any class having the function public static void main (String[ ] args) can run on the JVM as the starting point from which the Java program runs.

A detailed description of the flow 300 of the method according to the present invention will be made below.

Step 310: Create a Helper Thread and Attach it to the JVM

In step 310, a helper thread is created in the Java process corresponding to the Java program, and the helper thread is attached to Java virtual machine created in the Java process.

For example, it is possible to create the helper thread through a callback mechanism provided by the Java Virtual Machine Tool Interface (JVMTI) and attach the created helper thread to the JVM through methods provided by the Java Native Interface (JNI). JVMTI can be used to monitor some behaviors of the JVM. JNI is an interface that is provided to expand Java standard class library to support platform-dependent functionalities. The JNI interface permits to realize a part of the codes by using a lower-level language, then makes Java applications call these functions programmed in the lower-level language.

Specifically, a callback function is set at the position where the JVM launching initialization is finished. For example, using JVMTI, a callback function mechanism responding to the virtual machine initialization event is launched by the following codes.

```
jvmtiEventCallbacks callbacks; //declaration
memset(&callbacks, 0, sizeof(callbacks)); //initialization
callbacks.VMInit = &vmInit; // entry of the programmed callback function
    jvmti->SetEventCallbacks(&callbacks, sizeof(callbacks)); //finishing
    the setting
    jvmti->SetEventNotificationMode(JVMTI_ENABLE,
JVMTI_EVENT_VM_INIT, NULL); //enabling a notification of virtual
machine initialization event
```

The functionality of the above codes is to assign the address of the callback function vmInit( ) provided by the programmer to a variable VMInit with callbacks structure of jvmtiEventCallbacks type. The variable represents the entry of the callback function that is called when a virtual machine initialization event occurs. The setting is finished by calling the method SetEventCallbacks( ) a notification of a virtual machine initialization event is enabled by calling the method SetEventNotificationMode( ) and the setting of the callback function vmInit( ) is finished. In this way, when the virtual machine performs initialization, the callback function vmInit( ) will be executed. It is noted that, for simplifying the explanation, parameters of well-known methods or functions will not be described in the present specification. For example, function( ) is simply shown. For user defined functions, definition and description of parameters of such functions will also be omitted because the parameters can be arbitrarily defined by users. Those skilled in the art can fully understand how to implement the method of the present invention according to such description.

In the callback function vmInit( ) a new helper thread is created by calling the method RunAgentThread( ) of JVMTI.

Here, it is noted that not all the threads can directly use the JVM in a process that creates the JVM. In order to be distinguished from the created helper thread, threads in the Java process corresponding to Java applications are called “Java application thread”, while the Java application thread and the helper thread are collectively called Java thread. The Java application thread can directly access the JVM, while the helper thread cannot directly access the JVM. Thus, it is necessary to attach the current helper thread to the JVM environment through the method AttachCurrentThread( ) provided by the JNI interface. The object of conducting the above attachment is to enable the helper thread to access the thread stacks in the JVM. In order to cause the helper thread to be capable of rapidly responding to a thread blocking event, it is necessary to set the helper thread to a high scheduling priority.

Prior to a description of step 320, it is necessary to describe the relationship between Java threads in the user space and corresponding threads in the kernel space (herein referred to as “native task”). The call stack of Java threads is located within the JVM in the user space, while the call stack of native tasks is located in the kernel space. When a Java process enters the kernel through the system scheduling, its Java thread corresponds to a native task in the kernel, the native task is scheduled by the scheduler of the kernel onto the processor to be executed.

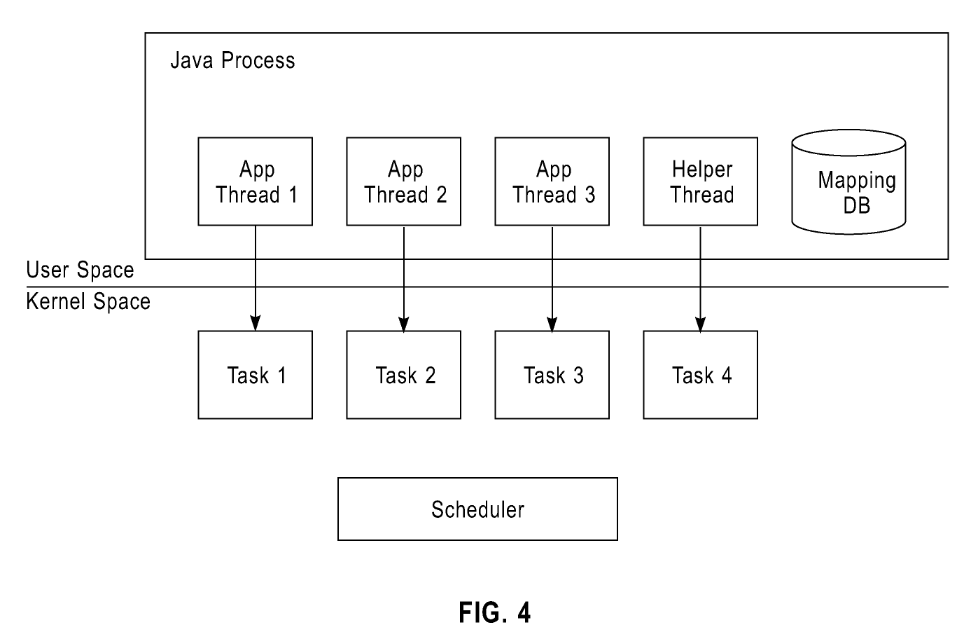

When a Java process has a plurality of Java application threads, each of these Java application threads correspond to one native task respectively, and the helper thread created in the above step 310 corresponds to one native task in the kernel likewise, as shown in FIG. 4. FIG. 4 is a schematic view showing a relationship between Java threads in user space and native tasks in kernel space. In FIG. 4, by way of example, three Java application threads and the created helper thread are shown. Java application threads 1 to 3 correspond to native tasks 1 to 3 respectively and the helper thread corresponds to native task 4. Java threads are identified by Java thread IDs in the user space, while native tasks are identified by native task IDs in the kernel space. Additionally, there is a corresponding stack of each Java thread in the JVM. When it detects that a native task (e.g. native task 2) is blocked in the kernel space, it is necessary to know the corresponding Java thread in the user space (e.g. Java application thread 2), so that it is possible to access the call stack in the JVM of the Java thread.

In order to achieve the above goal, when each Java thread is launched, it is necessary to establish a mapping relationship between the Java thread and a native task corresponding to the Java thread in the operating system kernel through a callback function. Specifically, similar to step 310, a callback function is set when the JVM is launched. For example, using JVMTI, a callback function mechanism responding to the thread launching event is launched by the following codes.

```
jvmtiEventCallbacks callbacks; // declaration
memset(&callbacks, 0, sizeof(callbacks)); // initialization
    callbacks.ThreadStart = &threadStart; // entry of the programmed
callback function
    jvmti->SetEventCallbacks(&callbacks, sizeof(callbacks)); // finishing
    the setting
    jvmti->SetEventNotificationMode(JVMTI_ENABLE,
JVMTI_EVENT_THREAD_START, NULL); // enabling a notification
of thread launching event
```

The functionality of the above codes is to assign the address of the callback function threadStart( ) programmed by the programmer to a variable ThreadStart with callbacks structure of jvmtiEventCallbacks type. The variable represents the entry of the callback function that is called when a thread launching event occurs. The setting is finished by calling the method SetEventCallbacks( ) a notification of thread launching event is enabled by calling the method SetEventNotificationMode( ) and the setting of the callback function threadStart( ) is finished. In this way, when the Java thread is launched, the callback function threadStart( ) will be executed.

In the callback function threadStart( ) a system call function, (e.g., gettid( ) on Linux), provided by the operating system kernel is called first to obtain the ID of the native task in the kernel space corresponding to the current Java thread, i.e., the native task ID. Then, a mechanism provided by the JNI is called to obtain the ID in the JVM of the current thread, i.e. the Java thread ID. Then, obtained native task ID and Java thread ID are stored in a mapping database as shown in FIG. 4 in an associated way. In such a manner, whenever a thread is launched, the thread will call the callback function threadStart( ) to store the mapping relationship between its Java thread ID in the user space and its native task ID in the kernel space. The following table 1 shows a possible example of the mapping relationship established in the case of FIG. 4.

TABLE 1

| Native | Java | Corresponding Thread |
|---|---|---|
| Task ID | Thread ID | in FIG. 4 |
| 5893 | 1 | Application thread 1 |
| 5901 | 2 | Application thread 2 |
| 5925 | 3 | Application thread 3 |
| 6012 | 21 | Helper thread |

It is noted that only the two columns of “Native Task ID” and “Java Thread ID” are actually stored in the mapping database, the last column is added for an explanation with reference to FIG. 4 so as to better understand the present invention. Additionally, it is noted that only when the Java program is a multi-thread program it is necessary to build the mapping database as described above. That is, when the Java program has only one main thread that uses main( ) as the starting point, the above step of building the mapping database can be omitted. For a better description of the present invention, the case of multi-threaded program (i.e. the case where the mapping database is built) is adopted as an example below to further describe the remaining steps of the method flow 300.

Step 320: Insert a Prober into the Operating System Kernel

First, an explanation regarding what is a prober is provided. The operating system provides an event callback mechanism for the system debugging and expanding. For example, in Linux system, a Kprobe/Jprobe mechanism is provided. This mechanism permits inserting a user defined function into particular location of the kernel code. Such function is called “Prober”.

A prober can be inserted into the operating system kernel by various means. For example, it is possible for the helper thread to call a function programmed in the programming language of the kernel through the JNI interface, so as to directly insert a corresponding function as a prober into the kernel scheduler. However, in order to achieve the above object more rapid and more efficient, a dynamic loading module mechanism provided by the OS can be used. The advantage of such a mechanism is to maintain the kernel in small size while being very flexible. Such a mechanism permits loading a module programmed by a user into the kernel to work with the kernel. In order to insert the prober into the operating system kernel, the following manner can be adopted: preprogramming a kernel monitoring module; loading the kernel monitoring module into the kernel to work; the helper thread transferring parameters to the kernel monitoring module and controlling the kernel monitoring module to insert the prober. By doing this, in comparison with the manner in which the helper thread directly inserts the prober, the work of the helper thread is simplified and the insertion of the prober is achieved by using a module of the kernel level, thereby achieving higher speed and a smaller performance overhead of the present invention.

Specifically, for example, in Linux system, insmod command is executed to explicitly load the kernel module. The kernel monitoring module according to one embodiment of the present invention is loaded into the kernel by executing insmod command. After the kernel monitoring module is loaded into the kernel, it will keep working in the kernel unless rmmod command is executed.

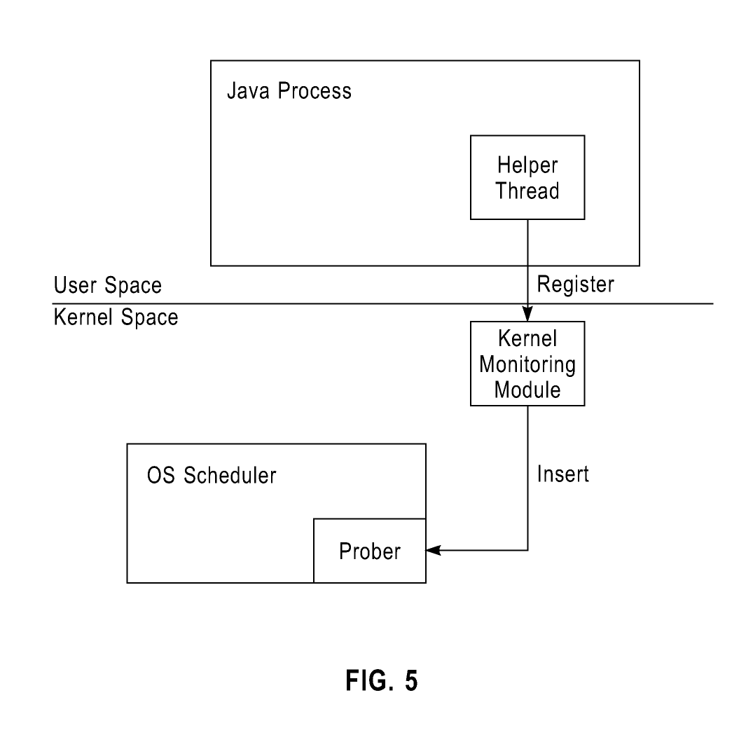

FIG. 5 is a schematic view showing one example of the process for step 320. In this embodiment, the prober is inserted into the operating system scheduler by the user defined module loaded into the operating system kernel (i.e. the above kernel monitoring module). After the helper thread is created, it registers with the loaded kernel monitoring module the ID of the Java process that is the monitored target and a native task ID corresponding to the helper thread. Then, the kernel monitoring module inserts the callback function programmed according to the registered process ID and the helper thread ID into the scheduler.

Specifically, for example, in Linux system, the insertion of the prober is achieved by the following codes:

jprobe.kp.symbol_name= switch_to;
jprobe.entry=j switch_to;

wherein the first statement specifies the kernel code position where the prober is to be inserted, the second statement specifies a user defined callback function j_switch_to. Thus, the insertion of a user defined callback function j_switch_to into the kernel function_switch_to is achieved. That is, whenever the kernel function_switch_to is called, the j_switch_to will be called. It is well known to those skilled in the art that each time when a task context switching occurs, the function_switch_to is called. That is, likewise, each time when a task context switching occurs, the inserted prober j_switch_to operates.

Step 330: the Prober Monitors Java Threads, and Sends a Signal to the Helper Thread when a Java Thread is Blocked

In step 330, the prober monitors the states in the operating system kernel of Java threads in the Java process and sends a signal to the helper thread in response to detect that a Java thread is blocked.

Since the prober j_switch_to is inserted into the function_switch_to, it can obtain all the parameters of switch_to, so that it may know the state of the native task that is scheduled out from the processor to trigger the task context switching event, and know which process the native task belongs to. That is, we can define the behavior of the prober in the self-defined function j_switch_to to achieve the process for step 330.

For example, the prober obtains two parameters from the kernel monitoring module in step 320: the kernel ID of the Java process (PID) and the ID of the native task corresponding to the helper thread (HTID). These two parameters are registered by the helper thread to the kernel monitoring module. The following judging logic is achieved in the prober: if a native task scheduled out from the processor corresponds to a Java thread in the Java process when the processor performs a task context switching and the native task is in blocked state, the prober sends a signal to the helper thread. That is, a signal is sent to the thread indicated by the HTID only when the following two conditions are satisfied at the same time: (1) the native task scheduled out belongs to the process indicated by the PID; and (2) the native task scheduled out is in blocked state.

It is noted that a native task could be scheduled out from the processor for many reasons. It is possible for the native task to be scheduled out from the processor because it is in blocked state or the allocated time slice has expired. In these cases, the prober will be called. Because a signal is sent only when the condition (2) is also satisfied, a native task scheduled out due to the expiration of the allocated time slice does not trigger the sending of a signal to the helper thread, thereby significantly reducing the performance overhead.

The sending of the signal can be realized in various manners. In one embodiment, for example, in Linux system, the system function send_signal can be used to send a predetermined signal to the helper thread. The helper thread keeps waiting for the signal all the time, and is wakened when the signal is received. In another embodiment, it is possible to establish a communication channel between the user space and the kernel space. When the above conditions (1) and (2) are satisfied at the same time, the prober communicates with the helper thread through the communication channel to notify the detection of block. Whichever manner is used, the signal sent to the helper thread contains the ID of the blocked native task.

Step 340: the Helper Thread Receives the Signal, Retrieves Call Stack Information from the JVM and Locates a Corresponding Position in Java Source Code by Using the Information

In step 340, the helper thread retrieves call stack information from the JVM in response to receive the signal from the operating system kernel, and locates a corresponding position in source code of the Java program by using the retrieved call stack information. The step of retrieving call stack information from the JVM includes: retrieving call stack information of a Java thread corresponding to the native task from the JVM according to the native task ID and the mapping relationship.

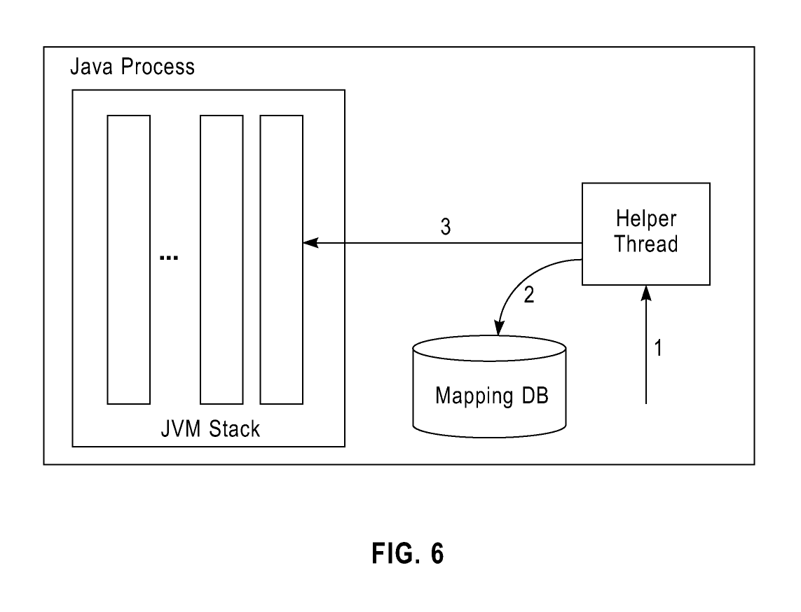

FIG. 6 is a schematic view showing one example of the process for step 340. The process for FIG. 6 corresponds to a case where a mapping database is built when a thread launches in the case of a multi-thread program. First, in step 1, the helper thread receives a signal from the kernel. The signal contains the ID of the blocked native task. For better understanding, FIG. 4 is explained as an example. Here it is assumed that the received native task ID is 5901. Then, in step 2, the helper thread queries a pre-built mapping database, e.g. the data structure as shown in Table 1. In the case where the native task ID is 5901, a corresponding Java thread ID is found from the mapping database (the corresponding Java thread ID is 2 in the case of Table 1). That is, the helper thread obtains a notification from the kernel: Java application thread 2 is blocked in the kernel. Then, in step 3, the helper thread retrieves call stack information from the stack corresponding to Java application thread 2 in the JVM according to the found Java thread ID (i.e., 2).

Specifically, it is possible to obtain the method name and position of the currently executed method of the stack of a specified thread by using the method GetFrameLocation( ) provided by JVMTI. Then, the obtained method name is used to call the method GetLineNumberTable( ) provided by JVMTI so as to obtain a mapping table of the position and the line number of the currently executed method. It is possible to find out at which line of the method the thread currently runs by iterating the table, thereby locating the corresponding position in Java source code. The corresponding position can be shown to those people that perform debugging or can be saved for a later bottleneck analysis.

Lastly, the handling of a special case is described. Those skilled in the art understand that, like ordinary Java application threads, the helper thread created in the present invention is also a Java thread and Java application threads and the helper thread are located within the same process, e.g., as shown in the case of FIG. 4. Additionally, the helper thread also corresponds to a native task in the kernel space. On the other hand, in step 330, the target monitored in the prober (i.e., the function j_switch_to) is the process, i.e., monitoring whether the scheduled out native task belongs to the process that is the monitoring target. As described above, this is achieved by checking whether the condition (1) is satisfied. Therefore, when the helper thread itself is blocked, since it detects that the conditions (1) and (2) are satisfied at the same time in the prober, the prober will send a signal to the helper thread in this case. However, this signal is useless and is irrelevant to the bottleneck related part of the source code itself of the Java program to be monitored, and this signal will be ignored.

Various manners can be adopted to ignore the signal caused by the helper thread itself being blocked. For example, at least two methods can be used below.

The first method is to conduct an extra judgment in the prober. In addition to the conditions of (1) the native task scheduled out belongs to the process indicated by the PID and (2) the native task scheduled out is in blocked state, a further condition (3) is set: the native task scheduled out is different from the ID of the native task corresponding to the helper thread, i.e., the native task scheduled out does not correspond to the helper thread in the user space. Then, in the case where the three conditions are satisfied at the same time, a signal is sent to the helper thread.

The second method is to judge in the helper thread. When the helper thread receives a signal containing the native task ID of the blocked native task from the operating system kernel (step 1 in FIG. 6), the helper thread queries the pre-built mapping database (step 2 in FIG. 6), e.g., the data structure as shown in Table 1. In the case where it is assumed that the native task ID is 6012, a corresponding Java thread ID is found from the mapping database (the corresponding Java thread ID is 21 in the case of Table 1). The helper thread compares the obtained Java thread ID with its own Java thread ID. When they match, it means the helper thread itself is blocked in the kernel. At this time, the helper thread ignores the signal and skips the execution of step 3 in FIG. 6.

In the above description, detailed description of the method flow 300 according to an embodiment of the present invention is provided. The method flow 300 is applicable to the case of single-core processor.

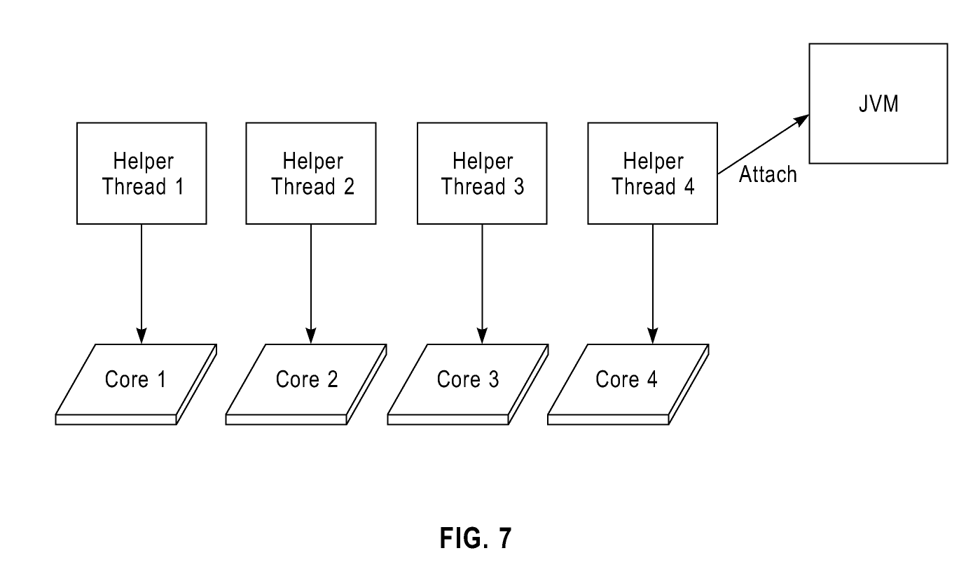

The method to detect and locate a bottleneck of Java program according to the present invention is applicable to the case of multi-core processor as well. In the case where the processor that executes the Java program is a multi-core processor, a plurality of helper threads is created. FIG. 7 is a schematic view showing an example of helper threads in the case of a quad-core processor. In FIG. 7, the number of the created helper threads is the same as the number of cores of the multi-core processor. That is, in the case of a quad-core processor, four helper threads 1 to 4 are created. Then, each of the four helper threads is bound to one core of the multi-core processor, respectively. That is, the helper thread 1 is bound to the processor core 1, the helper thread 2 is bound to the processor core 2, the helper thread 3 is bound to the processor core 3, and the helper thread 4 is bound to the processor core 4.

In order to achieve the above function, we need to modify step 310 in the method flow as follows.

In the callback function vmInit( ) according to the number of the processor cores, the method RunAgentThread( ) of JVMTI is called to create the same number of helper threads. Then, each running current helper thread is attached to the JVM through the method AttachCurrentThread( ) provided by the JNI interface, so that it is able to access the stack/heap information of the JVM. These helper threads are set to higher scheduling priority. Then, a system call sched_setaffinity( ) is called to bind the current thread to one processor core. In this way, the four helper threads are bound to four processor cores in a one-to-one relationship, so that it is possible to operate in a manner similar to a single helper thread on a single-core processor.

It is noted that the quad-core processor is only an example. The present invention is also applicable to a dual-core processor, an octal-core processor and a processor with more cores.

With the above method of the present invention, it is possible to accurately link a bottleneck found at native layer back to Java source code. i.e., to find a corresponding position in Java source code that causes the bottleneck in native layer. Therefore, the above method can find the reason that the Java thread's state changes in the case where there are not any indications at JVM layer. Additionally, the above method is a platform independent and self-contained method and does not need the help of other monitors or tools. Furthermore, the above method will not record stack information each time the method is called due to the use of signal mechanism, so it has no obvious performance overhead and will not have an adverse effect on the normal running of a target application.

It will be appreciated by those skilled in the art that, the embodiments of the invention can be provided in the form of method, system or computer program product. Therefore, the invention can take the forms of pure hardware embodiment, pure software embodiment, or combined hardware and software embodiment. The typical combination of hardware and software can be a general purpose computer system with computer program. When the program is loaded and executed, the computer system is controlled to perform the above method.

The invention can be embedded in a computer program product, which includes all features that allow the method described herein to be embodied. The computer program product is included in one or more computer readable storage medium (including, but not limited to, magnetic disk storage, CD-ROM, optical storage, etc), the computer readable storage medium has computer readable program code stored therein.

The invention has been described with reference to the flowchart and/or block diagram of method, system and computer program product according to the invention. In evidence, each block in the flowchart and/or block diagrams and the combination of blocks in the flowchart and/or block diagram can be implemented by computer program instructions. These computer program instructions can be provided to the processor of general purpose computer, dedicated computer, embedded processor or other programmable data processing apparatus to generate a machine, so that the instructions (by the processor of computer or other programmable data processing apparatus) generate a means for implementing the functions provided in one or more blocks of the flowchart and/or block diagram.

These computer program instructions can also be stored in read memories of one or more computers, each of such memories can instruct computer or other programmable data processing apparatus to put into effect in a particular manner, so that the instructions stored in computer readable memory produce a manufacture article. The manufacture article includes an instruction device that implements functions provided in one or more blocks of the flowchart and/or block diagram.

The computer program instructions can also be loaded into one or more computers or other programmable data processing apparatus such that a series of operation steps is executed on the computer or other programmable data processing apparatus, thereby a computer-implemented process is generated on each of such apparatus, resulting in that the instructions executed on the apparatus provide a method of implementing the steps provided in one or more blocks of the flowchart and/or block diagram.

While the principle of the present invention has been described in connection with the preferred embodiments of the invention above, these descriptions are only illustrative, but not to be construed as limit to the invention. Those skilled in the art could make any modification and variation to the invention without departing from the spirit and scope of the invention as defined by the appended claims.

What is claimed is:

1. A method to locate a bottleneck of Java program comprising the steps of:
creating a helper thread in a Java process corresponding to the Java program, and attaching the helper thread to a Java virtual machine (JVM) created in the Java process;
inserting a prober into an operating system kernel;
monitoring states, with the prober, in the operating system kernel, of Java threads in the Java process, and sending a signal to the helper thread in response to detect that a Java thread is blocked; and
retrieving call stack information from the JVM in response to receive the signal from the operating system kernel, and locating the position in source code of the Java program that causes the block using the retrieved call stack information wherein the retrieving is performed by the helper thread.

2. The method according to claim 1, wherein in the case where the processor that executes the Java program is a multi-core processor, creating a plurality of helper threads.

3. The method according to claim 2, wherein a number of the plurality of helper threads created equals a number of cores of the multi-core processor.

4. The method according to claim 3, wherein each of the plurality of helper threads created is bound to one core of the multi-core processor, respectively.

5. The method according to claim 1, further comprising: in response to the launch of each Java thread, establishing a mapping relationship between the Java thread and a native task corresponding to the Java thread in the operating system kernel by a callback function.

6. The method according to claim 5, wherein the signal contains an ID of the blocked native task, and wherein retrieving call stack information from the JVM includes: retrieving call stack information of the Java thread corresponding to the native task from the JVM according to the native task ID and the mapping relationship.

7. The method according to claim 1, wherein the prober is inserted into the scheduler of the operating system, and operates when a task context switching occurs.

8. The method according to claim 7, wherein the prober is inserted into the scheduler by a user defined module loaded into the operating system kernel.

9. The method according to claim 7, wherein sending a signal to the helper thread in response to detect that a Java thread is blocked includes: if a native task scheduled out from the processor corresponds to a Java thread in the Java process when the processor performs a task context switching and the native task is in blocked state, sending the signal from the prober to the helper thread.

10. An apparatus to locate a bottleneck of Java program comprising:
means configured to create a helper thread in a Java process corresponding to a Java program and attaching the helper thread to a Java virtual machine (JVM) created in the Java process;
means configured to insert a prober into an operating system kernel;
means configured to monitor states in the operating system kernel, of Java threads in the Java process, and sending a signal to the helper thread in response to detect that a Java thread is blocked, by the prober; and
means configured to retrieve call stack information from the JVM in response to receive the signal from the operating system kernel and locating the position in source code of the Java program that causes the block using to the retrieved call stack information, in the helper thread.

11. An article of manufacture tangibly embodying computer readable instructions which, when implemented, cause a computer to carry out the steps of a method comprising:
creating a helper thread in a Java process corresponding to the Java program, and attaching the helper thread to a Java virtual machine (JVM) created in the Java process;
inserting a prober into an operating system kernel;
monitoring states in the operating system kernel, of Java threads in the Java process, and sending a signal to the helper thread in response to detect that a Java thread is blocked, wherein the monitoring is performed by the prober; and
retrieving, with the helper thread, call stack information from the JVM in response to receive the signal from the operating system kernel and locating the position in source code of the Java program that causes the block using to the retrieved call stack information.
